(19) United States
(12) Patent Application Publication
(10) Pub. No.: US 2008/0025598 A1
(43) Pub. Date: Jan. 31, 2008

(54) Device and method for phase adjustment

(76) Inventor: Masahiro Ogawa, Osaka (JP)

Correspondence Address: MCDERMOTT WILL & EMERY LLP, 600 13TH STREET, NW, WASHINGTON, DC, 20005-3096, US

(21) Appl. No.: 11/878,838

(22) Filed: Jul. 27, 2007

(30) Foreign Application Priority Data
Jul. 28, 2006 (JP) 2006-205905
Jul. 4, 2007 (JP) 2007-176036

(51) Int. Cl. G06K 9/00

(52) U.S. Cl. 382/162

(57) ABSTRACT

A luminance level detecting unit calculates a luminance of a digital imaged signal in a plurality of pixels within a first pixel region of an imaging element. A variation calculating unit calculates a variation value indicating signal variation of the digital imaged signal in a plurality of pixels within a second pixel region in the imaging element. A timing adjusting unit adjusts the phase of a pulse based on the result of calculation of the luminance level detecting unit and the result of calculation of the variation calculating unit.

### BACKGROUND OF THE INVENTION

1. Field of the Invention

The present invention relates to phase adjusting devices and phase adjusting methods for adjusting the phase (timing) of the pulse used in imaging processes in digital cameras.

2. Description of the Related Art

The digital camera (digital still camera, digital video camera, cellular phone with camera etc.) is a camera that converts an analog imaged signal imaged by an imaging element such as a CCD and a MOS sensor to a digital imaged signal, and records the same after performing a predetermined process thereon. The pulse for driving the imaging element, the pulse for detecting a signal level, and the like are required in order to image a subject by means of the imaging element. It is difficult to adjust the phase (timing) of such pulses in hardware designing as they contain manufacturing variation. Normally, engineers perform phase adjustment after manufacturing, and store the information indicating the adjusted phase in a storage region to set the phase.

The background art document relating to the present invention includes Japanese Laid-Open Patent Publication No. 2005-151081. In this document, an image is retrieved with minimum exposure time, whereby the noise component becomes minimum. That is, the phase is adjusted so that the high-frequency component becomes minimum.

Conventionally, in manufacturing digital cameras, the phase of the pulse of an imaging element is adjusted after manufacturing, and the information thereof is set for all the digital cameras in the same manufacturing process. Such an adjusting method, however, can not respond to the characteristic variation of the imaging element. The point at which the signal level is detected thus shifts from the optimum point due to variation in the imaged signal caused by the characteristic variation, and the maximum signal level may not be obtained or the S/N (signal-to-noise) ratio may be degraded.

Recently, in the field of medical cameras etc., in particular, there arises a possibility of replacing the imaging element after manufacturing the digital camera. If the imaging elements differ, the phases of the pulses for driving the imaging elements obviously also differ, and thus the phase must be readjusted. Furthermore, signal delay occurs in the cable connecting the imaging element and a signal processing device. Thus, the phase must be readjusted when the delay amount changes due to replacement of cable etc. However, it is difficult to replace the imaging element or the connecting cable easily if engineers perform readjustment of the phase.

Moreover, accuracy is not very high in the method according to the above document, since the characteristic of the pulse to be adjusted is not taken into consideration and the optimum phase is obtained through the same method for a plurality of pulses.

### SUMMARY OF THE INVENTION

Therefore, it is an object of the present invention to adjust the phase of the pulse used in imaging automatically and with high accuracy without the need of manual readjustment.

In order to achieve the above object, an automatic phase adjusting device according to the present invention relates to an automatic phase adjusting device for adjusting a phase of a pulse used in an imaging process based on a digital imaged signal obtained by converting an analog imaged signal generated in the imaging process by an imaging element to a digital value for each pixel; the automatic phase adjusting device including a luminance level detecting unit for calculating a luminance of the digital imaged signal in a plurality of pixels within a first pixel region in the imaging element; a variation calculating unit for calculating a variation value indicating signal variation of the digital imaged signal in a plurality of pixels within a second pixel region in the imaging element; and a timing adjusting unit for adjusting the phase of the pulse based on a calculation result of the luminance level detecting unit and a calculation result of the variation calculating unit.

A phase adjusting method according to the present invention relates to a phase adjusting method of adjusting a phase of at least one of a first pulse used in detecting a level of an analog imaged signal outputted from an imaging element, a second pulse for detecting a signal level that acts as a reference in a correlated double sampling process performed when converting the analog imaged signal to a digital value for each pixel, and an AD clock signal used in converting the analog imaged signal to the digital value for each pixel, the method including the steps of detecting a first phase at which a luminance of the analog imaged signal becomes maximum with the second pulse and the AD clock signal fixed at respective initial values and the phase of the first pulse changed; and setting the detected first phase as the phase of the first pulse.

According to the present invention, each phase of the pulse (pulse DS1, pulse DS2, ADCLK) outputted from a TG (timing generator) to be used in imaging can be automatically adjusted. Therefore, the phases of the pulses outputted from the TG can be automatically adjusted even when the imaging element itself is replaced, or when the characteristics of the imaging element are changed due to external factors (temperature, voltage change etc.) and aged deterioration and the signal delay amount from the imaging element to the signal processing unit is changed. In the manufacturing process, the phase of the pulse is automatically adjusted to an optimum state according to variation of the individual imaging element.

Furthermore, high precision automatic adjustment can be achieved by adjusting the phase of the pulse through individual methods in view of the characteristics of each pulse.

Since the timing adjustment of the pulse used in imaging in the digital camera can be automatically performed, the present invention is useful at least for the digital camera.

### BRIEF DESCRIPTION OF THE DRAWINGS

The present invention, together with other objects and features thereof, will become apparent by understanding the following description of preferred embodiments, and are clearly defined in the appended claims. Those skilled in the art will find many other advantages of the present invention that are not mentioned herein by implementing the present invention.

FIG. 1 shows an overall configuration of a digital camera according to the present invention;

FIG. 2 shows a signal component outputted from an imaging element in time-series;

FIG. 3 is an overall flowchart of phase adjustment according to the present invention;

FIG. 4 is a timing chart of the signal component used in the phase adjustment of a pulse DS2 according to the present invention;

FIG. 5 is a detailed flowchart of the phase adjustment of the pulse DS2 according to the present invention;

FIG. 6 is a timing chart of the signal component used in the phase adjustment of a pulse DS1 according to the present invention;

FIG. 7 is a detailed flowchart of the phase adjustment of the pulse DS1 according to the present invention;

FIG. 8 is a timing chart of the signal component used in the phase adjustment of an ADCLK according to the present invention;

FIG. 9 is a detailed flowchart of the phase adjustment of the ADCLK according to the present invention;

FIG. 10 shows an overall configuration of a digital camera according to a first variation of the present invention;

FIG. 11 shows the signal component outputted from the imaging element in time-series when signal quality is bad according to a second variation of the present invention;

FIG. 12 illustrates an adjustment range of phase adjustment according to a third variation of the present invention;

FIG. 13 schematically shows prediction of an optimum position of the pulse DS1 and the ADCLK using the pulse DS2 in the third variation;

FIG. 14 shows an overall configuration of a digital camera according to a fifth variation of the present invention;

FIG. 15A is a histogram output result according to the fifth variation of the present invention;

FIG. 15B is a histogram output result according to the fifth variation of the present invention;

FIG. 15C is a histogram output result according to the fifth variation of the present invention;

FIG. 16 shows an overall configuration of a digital camera according to a sixth variation of the present invention;

FIG. 17 shows an example of a block memory according to the sixth variation of the present invention;

FIG. 18 shows an overall configuration of a digital camera according to a seventh variation of the present invention;

FIG. 19A shows a setting example of a pixel region according to the seventh variation of the present invention;

FIG. 19B shows an example of a signal level according to the seventh variation of the present invention;

FIG. 20 shows an overall configuration of a digital camera according to an eighth variation of the present invention;

FIG. 21 shows high speed read-out according to an eleventh variation of the present invention;

FIG. 22 shows the high speed read-out in detail according to the eleventh variation of the present invention;

FIG. 23 is a phase adjustment timing chart according to a twelfth variation of the present invention;

FIG. 24 shows image storage area control according to a thirteenth variation of the present invention; and

FIG. 25 shows shading correction control according to the thirteenth variation of the present invention.

### DETAILED DESCRIPTION OF THE INVENTION

Preferred embodiments of the present invention will now be described with reference to the accompanying drawings. The embodiments described below are merely given by way of examples, and various modifications may be made including the variations hereinafter described.

### (Device Configuration)

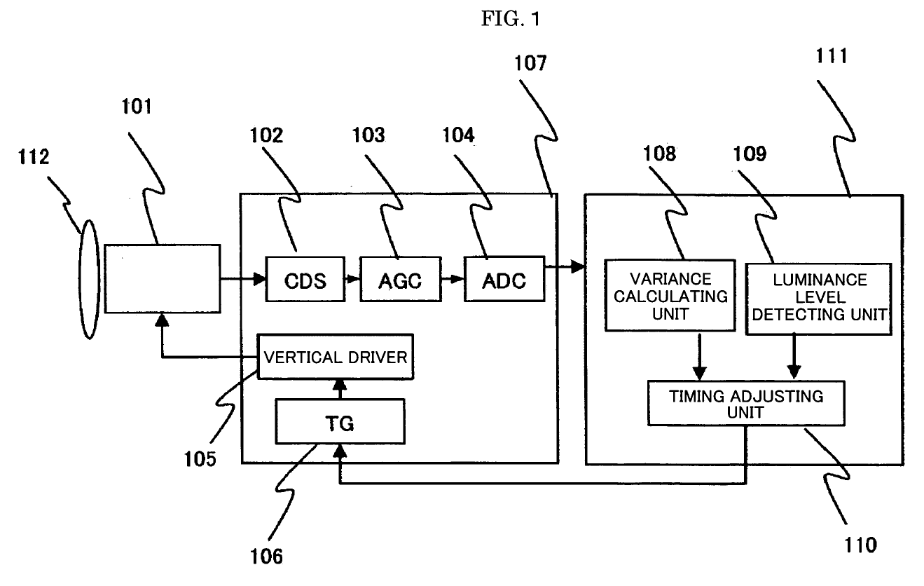

FIG. 1 shows the overall configuration of a digital camera in the present embodiment. The digital camera according to the present embodiment includes an optical lens 112 for converging a subject image, an imaging element 101 (following description made on CCD by way of example) for imaging the subject image converged by the optical lens 112, an analog front end 107 for converting an analog imaged signal outputted from the imaging element 101 to a digital imaged signal after performing a predetermined process to the analog imaged signal; and a Digital Signal Processor (hereinafter abbreviated as DSP) 111 for generating an imaged signal by performing a predetermined process (color correction, YC process, and the like) on the digital imaged signal outputted from the analog front end 107.

The imaging element 101 includes a plurality of pixels, and the plurality of pixels include an effective pixel region used in imaging the subject and an OB pixel region arranged in a light-shielded state at the periphery of the effective pixel region and used in detecting an Optical Black level (hereinafter abbreviated as OB level).

The analog front end 107 includes a Correlated Double Sampler (hereinafter abbreviated as CDS) 102 for performing correlated double sampling to set the signal level of the analog imaged signal outputted from the imaging element 101, an Automatic Gain Controller (hereinafter abbreviated as AGC) 103 for amplifying the signal outputted from the CDS 102 at an adjustable gain, an Analog Digital Converter (hereinafter abbreviated as ADC) 104 for converting the signal amplified by the AGC 103 to the digital imaged signal, a Timing Generator (hereinafter abbreviated as TG) 106 for generating a pulse to be used in imaging, and a vertical driver 105 for outputting the pulse generated by the TG 106 to the imaging element 101.

Furthermore, the pulse DSP 111 includes a variance calculating unit 108 (serving as variation calculating unit for calculating variance of the signal level of each pixel, which is a characteristic constituent element of the present invention), a luminance level detecting unit 109 for detecting luminance by obtaining an average value of the signal levels of the pixels within a predetermined region, and a timing adjusting unit 110 for adjusting the phase (timing) of the pulse to be generated by the TG 106 based on the results of the calculation and detection of the variance calculating unit 108 and the luminance level detecting unit 109. The analog imaged signal outputted from the imaging element 101 is stored in a memory (SDRAM), which is not shown. The variance calculating unit 108 (variance calculating unit) and the luminance level detecting unit 109 read data of each pixel from the SDRAM (not shown), and perform calculation based on the signal thereof.

### (Signal Component Outputted from the Imaging Element)

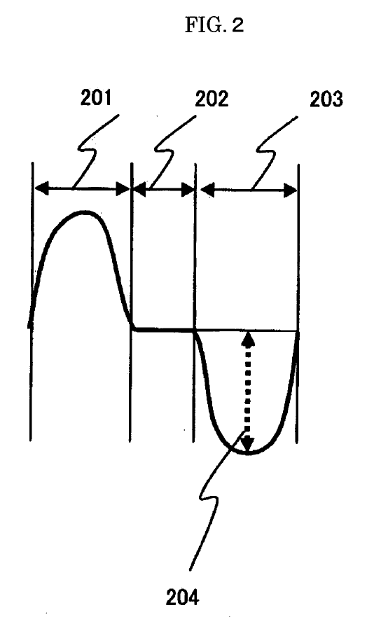

FIG. 2 shows a component of the analog imaged signal outputted from the imaging element 101 in time-series. As shown in FIG. 2, the analog imaged signal includes a reset period 201, a reference period 202, and a signal period 203. The reset period 201 is a period used to reset the imaging element 101. The reference period 202 is a period in which a reference voltage is outputted from the imaging element 101, where the signal that acts as a reference when performing correlated double sampling in the CDS 102 is detected. The signal period 203 is a period in which the signal voltage is outputted, where the signal level 204 of the analog imaged signal can be obtained by sampling the signal voltage at the peak during the signal period 203 and the reference voltage during the reference period 202 and taking the difference therebetween. In FIG. 2, the downward direction in the figure indicates that the signal component is in the positive direction.

### (Overall Flow)

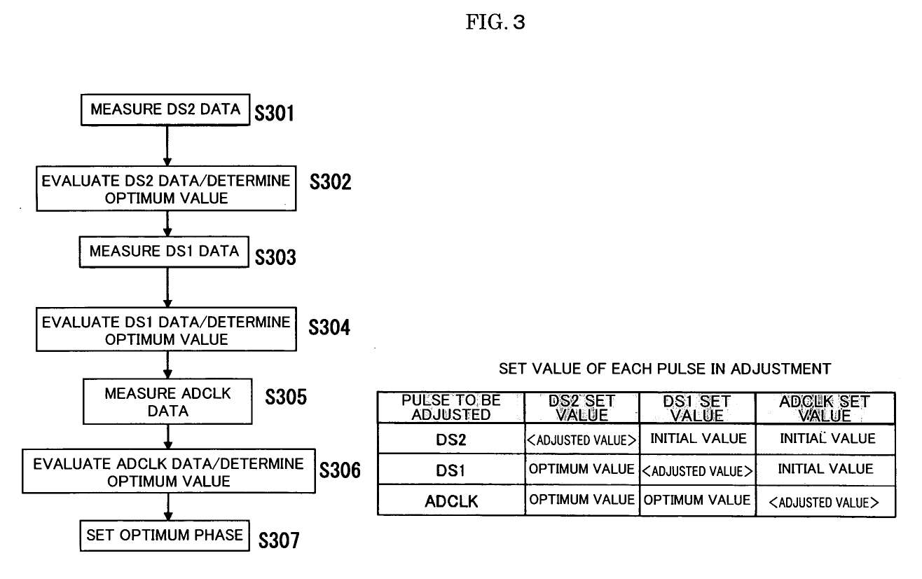

FIG. 3 shows an overall flowchart of phase adjustment of each pulse according to the present embodiment. The phase adjustment in the present embodiment is performed mainly by the variance calculating unit 108, the luminance level detecting unit 109, and the timing adjusting unit 110. The pulse to be adjusted is a pulse DS2, a pulse DS1, and an ADCLK. The pulse DS2 (first pulse) is a pulse for sampling the component of the analog imaged signal at the peak during the signal period 203. The pulse DS2 is desirably phase-adjusted so that the rising edge is produced when the component of the analog imaged signal outputted from the imaging element 101 becomes the peak. The pulse DS1 (second pulse) is a pulse for sampling the signal component acting as a reference in the correlated double sampling. The pulse DS1 is desirably phase-adjusted so that the rising edge is produced at the center of the reference period. The signal level of the analog imaged signal calculated by the CDS 102 is just the difference between the signal component at the peak in the rising of the pulse DS2 and the signal component within the reference period defined by the rising of the pulse DS1. The ADCLK (AD clock signal) is a clock signal of the ADC 104, and is desirably phase-adjusted so that the result of AD conversion does not vary.

In the present invention, the data necessary in determining the pulse DS2 is measured while shifting the phase of the pulse DS2 from an initial value after fixing the pulse DS1 and the ADCLK to the initial values defined in advance (S301). An optimum phase for the pulse DS2 is determined by evaluating the data (step S302). After the pulse DS2 is determined, data necessary in determining the pulse DS1 is measured while shifting the phase of the pulse DS1 from the initial value with the pulse DS2 fixed to the determined optimum value and the ADCLK fixed to the initial value (step S303). The optimum phase for the pulse DS1 is determined by evaluating the data (step S304). After the pulse DS1 and the pulse DS2 are determined, data necessary in determining the ADCLK is measured while shifting the phase of the ADCLK from the initial value after fixing the pulses DS1 and DS2 to the respective optimum values (step S305). The data is then evaluated to determine the optimum phase for the ADCLK (step S306, step S307). After the optimum phases for the pulse DS1, the pulse DS2, and the ADCLK are determined, information pertaining to the determined optimum phases is set in a register in the TG 106, so that the pulse is generated at the optimum phase. The details of each step will now be described.

### (Adjustment of Pulse DS2)

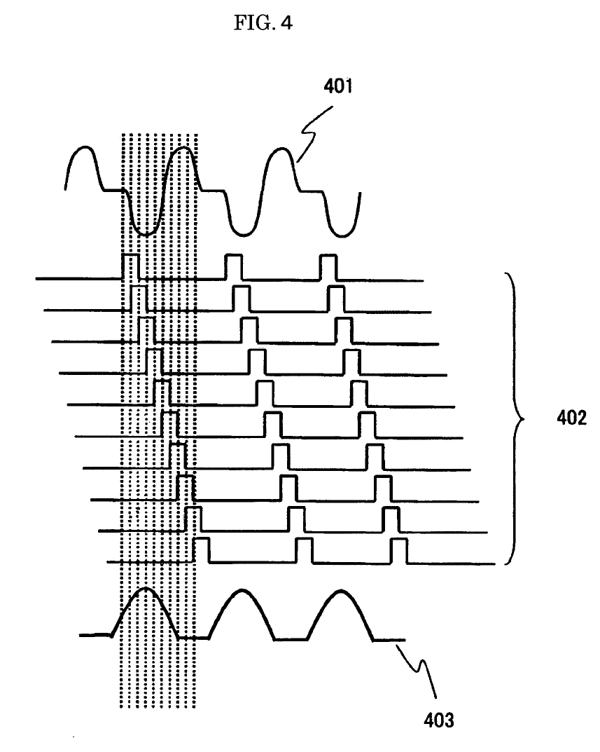

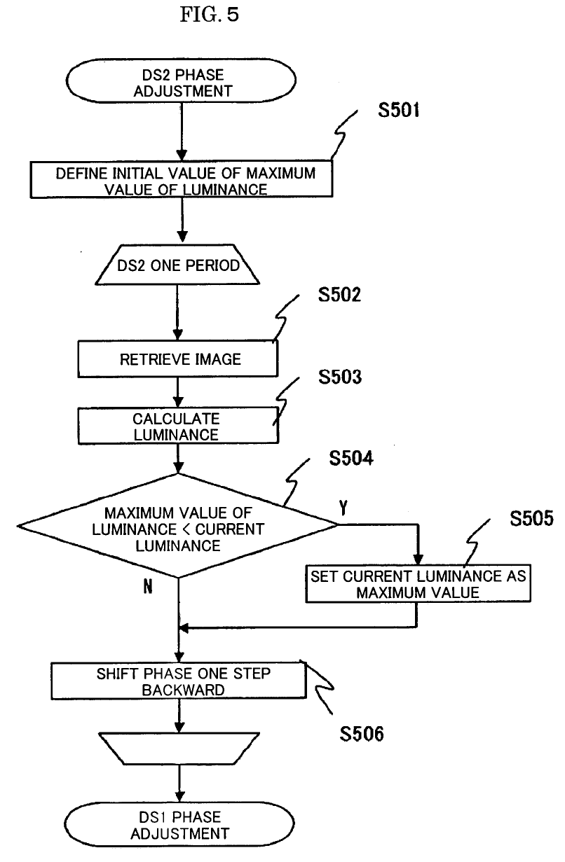

First, the phase adjustment of the pulse DS2 will be described with reference to FIGS. 4 and 5. FIG. 4 is a timing chart of the signal component of the analog imaged signal used in the phase adjustment of the pulse DS2, and FIG. 5 is a flowchart showing in detail the phase adjustment of the pulse DS2. The flowchart of FIG. 5 corresponds to steps S301 and S302 in the flowchart of FIG. 3.

In FIG. 4, reference numeral 401 indicates an analog imaged signal or an imaging element output signal, and reference numeral 403 indicates a luminance signal. The luminance in the phase adjustment of the pulse DS2 is defined as an average value of the signal level of each pixel in a partial region or an entire region (hereinafter referred to as a pulse DS2 detection region) of the effective pixel region of the imaging element 101. When the imaging element output signal 401 is as shown in the figure, the luminance signal 403 appears as a convex shape with a peak in the figure when the pulse DS2 is shifted as in the region indicated by 402 in the figure with the pulse DS1 and the ADCLK in the fixed state. The phase at which the luminance signal 403 becomes the largest is determined as the phase at which the pulse DS2 becomes optimum. The signal level for each pixel in the image data is the difference between a peak value of the signal component determined by the pulse DS2 and the reference signal component determined by the pulse DS1, as described above. Therefore, the difference becomes negative in areas where the magnitude relation of the signal component in the pulse DS2 and the signal component in the pulse DS1 is reversed, but is indicated as 0 in the figure since the negative is not defined for the signal level in this example.

Description will be made in further detail with reference to FIG. 5. First, in step S501, the initial value of the maximum value of the luminance is defined. Such a small value as to be immediately updated when there is a signal component having a magnitude greater than or equal to a predetermined magnitude is set as the initial value of the maximum value of the luminance. In step S502, the analog imaged signal imaged by the imaging element 101 is retrieved. In this case, the pulse DS1 and the ADCLK are set to the initial values, and the point slightly later in time-series than the initial value of the pulse DS1 is set as the initial value of the pulse DS2. In step S503, the luminance within the pulse DS2 detection region (first pixel region) of the retrieved analog imaged signal is calculated. That is, the average value of the signal level of each pixel within the pulse DS2 detection region is calculated. Since the pixels whose signal levels are greater than or equal to a predetermined value are assumed as being saturated, sampling is preferably performed excluding such pixels. The process of step S503 is performed in the luminance level detecting unit 109. In the next step S504, the calculated luminance is compared with the maximum value of the luminance up to the present point. When the calculated luminance is larger as a result of the comparison, the calculated luminance is set as the current maximum value in step S505. When the maximum value of the luminance up to the present point is larger, updating of the maximum value of the luminance is not performed. The processes of steps S504 and S505 are performed by the timing adjusting unit 110. In step S506, a command is then sent from the timing adjusting unit 110 to the TG to shift the phase of the pulse DS2 one step backward with the pulse DS1 and the ADCLK fixed. When the phase is shifted by one step, the processes of steps S502 to S506 are again performed, and comparison of the maximum values of the luminance is performed. This process is repeatedly performed for one period, and the phase at which the luminance becomes maximum is determined as the optimum pulse DS1.

### (Adjustment of Pulse DS1)

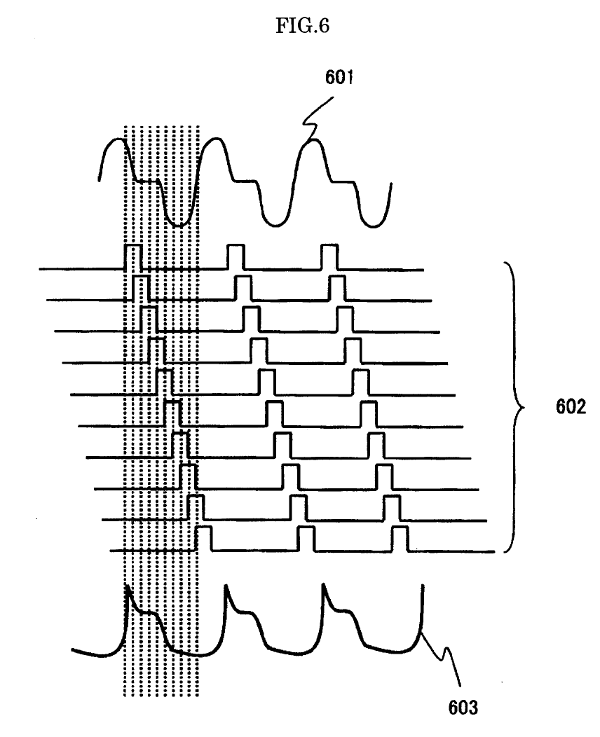

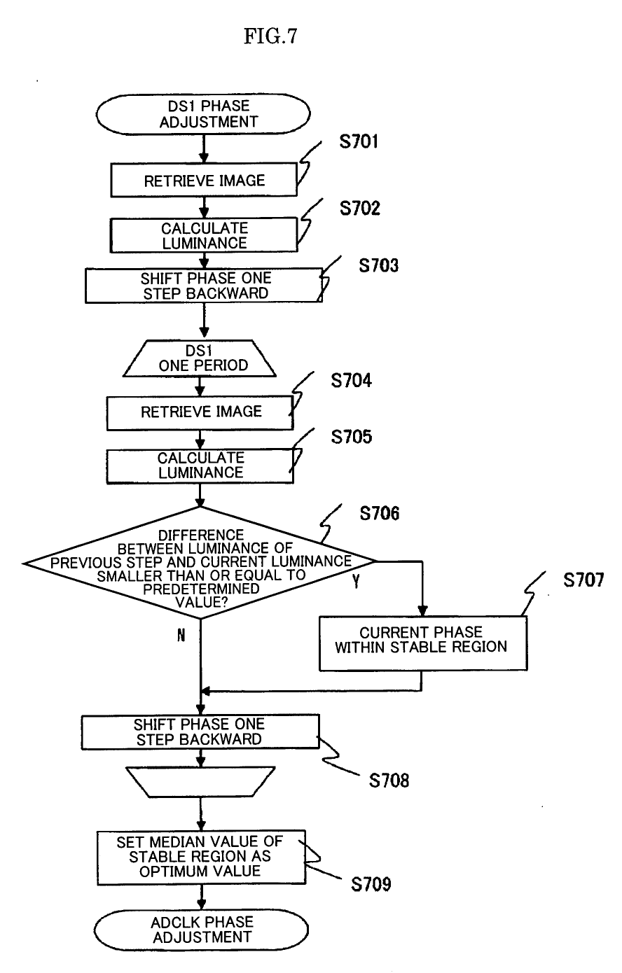

Next, the phase adjustment of the pulse DS1 will be described with reference to FIGS. 6 and 7. FIG. 6 is a timing chart of the signal component used in the phase adjustment of the pulse DS1. FIG. 7 is a flowchart showing in detail the phase adjustment of the pulse DS1, the flowchart corresponding to steps S303 and S304 in the flowchart of FIG. 3.

In FIG. 6, reference numeral 601 indicates the imaging element output signal, and reference numeral 603 indicates the luminance signal. In the phase adjustment of the pulse DS1 as well, the luminance is defined as an average value of the signal level of each pixel in a partial region or an entire region (hereinafter referred to as pulse DS1 detection region) of the effective pixel region of the imaging element 101. When the imaging element output signal 601 is as shown in FIG. 6, the luminance signal 603 rapidly decreases, becomes substantially constant in the reference period, and again decreases to 0 at the point matching the pulse DS2 when the pulse DS1 is shifted as in the region indicated by 602 in the figure from the initial value with the pulse DS2 and the ADCLK in the fixed state. The optimum value of the phase of the pulse DS1 is determined so that the rising edge of the pulse comes at the center of an interval (hereinafter referred to as a stable region) where the luminance signal 603 is substantially constant.

Description will be made in further detail with reference to FIG. 7. First, in step S701, the analog imaged signal imaged by the imaging element 101 is retrieved after setting the pulse DS1 and the ADCLK to the initial values, and the pulse DS2 to the optimum value determined by the adjusting method described above.

In step S702, the luminance within the pulse DS1 detection region (second pixel region) of the retrieved analog imaged signal is calculated. That is, the average value of the signal level of each pixel in the pulse DS1 detection region is calculated. Since the pixels whose signal levels are greater than or equal to a predetermined value are assumed as being saturated, sampling is preferably performed excluding such pixels. The process of step S702 is performed in the luminance level detecting unit 109.

In step S703, the phase of the pulse DS1 is shifted one step backward with the pulse DS2 and the ADCLK fixed. In step S704, the analog imaged signal imaged by the imaging element 101 is retrieved, and the luminance within the pulse DS1 detection region of the retrieved analog imaged signal is calculated in step S705.

In step S706, the difference between the luminance calculated from the analog imaged signal retrieved at the phase of the pulse DS1 one step before and the luminance calculated from the analog imaged signal detected at the current phase is taken, and determination is made on whether or not the difference is smaller than or equal to a predetermined threshold value. When the difference is smaller than or equal to the predetermine threshold value, the phase of the current pulse DS1 is determined as being within the stable region and when not smaller than or equal to the predetermined threshold value, the current phase is determined as not being within the stable region in step S707.

In step S708, the phase of the pulse DS1 is shifted one step backward with the pulse DS2 and the ADCLK fixed. After the phase is shifted by one step, the processes of steps S704 to S708 are again performed, and determination is made on whether or not the shifted phase is within the stable region. The process is repeatedly performed for one period, and determination is made from which phase to which phase the stable region includes. Finally, in step S709, the median value of the phase determined as the stable region is determined as the optimum value of the pulse DS1. When determined that a plurality of stable regions exist non-continuously in the final determination of the stable region, the interval (area) of shorter period length may be ignored or the interval (area) of the longest period length may be determined as the stable region.

When the noise component is large, there is a possibility that the stable region may be mistakenly detected or may not be detected with only the difference between two pixels. In such a case, the difference between the average value of the luminance at three or more phases and the average value of the luminance at the current phase may be calculated and compared with a threshold value by using, e.g., a filter calculation. Alternatively, the variance of the luminance at three or more phases may be calculated and compared with the threshold value.

The initial values of the pulse DS1 used in respective adjustment flows of the pulse DS1 and the pulse DS2 may be the same or may be different. For instance, the initial value of the pulse DS1 in the adjustment flow of the pulse DS2 is set so as to be in the vicinity of the reference period anticipated from the design specification, and the initial value of the pulse DS1 for retrieving the first image data in the adjustment flow of the pulse DS1 is set so as to be within the reset period to detect the rapid decrease of the luminance signal.

### (Adjustment of ADCLK)

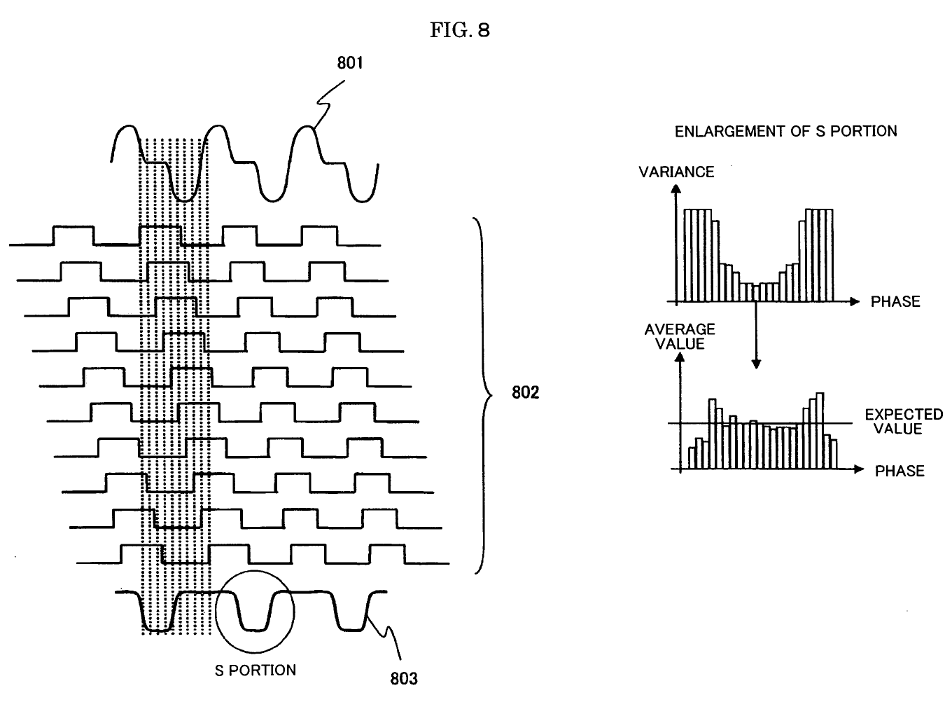

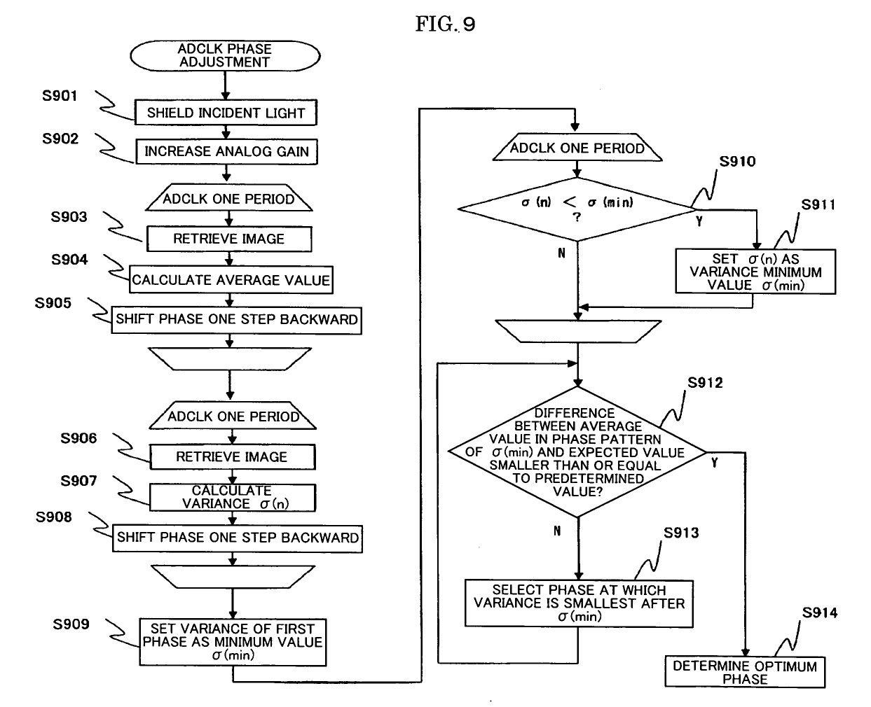

The adjustment of the ADCLK will now be described with reference to FIGS. 8 and 9. FIG. 8 is a timing chart of the signal component used in the phase adjustment of the ADCLK. FIG. 9 is a flowchart showing the details of the phase adjustment of the ADCLK, and the flowchart corresponds to steps S305 and S306 in the flowchart of FIG. 3.

In FIG. 8, reference numeral 801 indicates an imaging element output signal, and reference numeral 803 indicates variance. The variance is defined herein as the variance of the signal level of each pixel under the condition of:

the imaging element 101 is in a light-shielded state; and

basis of the output of a pixel group positioned in a partial region or an entire region (hereinafter referred to as an ADCLK detection region) in the region including at least one of the effective pixel region and the OB pixel region.

That is, the variance is a value indicating to what extent the signal level of each pixel, which is constant in an ideal condition, is varied due to the fact that the imaging element 101 is light-shielded. Therefore, the ADCLK must be set so that the variance becomes small. The pixel region for calculating the luminance and the pixel region for calculating the variance may be the same or may be different. When the state of the pulse is the state shown in 801 in the figure, the variance will have a concave shape indicated by 803 when the ADCLK is shifted from the initial value as in the region indicated by 802 with the pulse DS1 and the pulse DS2 fixed to the optimum value. The phase of the ADCLK must be determined so that the variance becomes the smallest value, but the variance may become minimum at a wrong position for some reason. Therefore, the luminance within the ADCLK detection region is compared with a predetermined expected value at the phase at which the variance is determined as minimum. Since the OB pixel region is light-shielded, the expected value serving as a DC offset in the design specification exists. When the luminance within the ADCLK detection region is far off from the expected value, the ADCLK cannot be concluded as being optimum. Therefore, when the difference between the luminance and the predetermined expected value is less than or equal to a predetermined threshold value at the phase at which the variance is determined as minimum, that phase is determined as the optimum value of the ADCLK. However, when the difference between the luminance and the predetermined expected value is greater than the predetermined threshold value, determination is made on whether or not the difference between the luminance and the predetermined expected value is less than or equal to the predetermined threshold value at the phase at which the variance is the next smallest. The minimum value of the ADCLK is determined by repeating the above processes.

A method of light-shielding the imaging element 101 includes shielding the incident light by closing a mechanical shutter. Since the light-shielded state is obtained from the beginning when having the OB pixel region as the ADCLK detection region, the mechanical shutter does not necessarily need to be closed.

The adjustment of the ADCLK will be described in further detail with reference to FIG. 9. In step S901, the incident light is shielded by closing the mechanical shutter. Such a step is not required when having the OB pixel region as the ADCLK detection region. In the next step S902, the analog gain is increased to amplify only the noise component. In step S903, the analog imaged signal imaged by the imaging element 101 is retrieved with the pulse DS1 and the pulse DS2 set to the determined optimum values and the ADCLK as the initial value. In step S904, the luminance within the ADCLK detection region of the retrieved analog image signal is calculated. That is, the average value of the signal level of each pixel within the ADCLK detection region is calculated. The process of step S904 is performed in the luminance level detecting unit 109. In step S905, the phase of the ADCLK is shifted one step backward with the pulse DS1 and the pulse DS2 fixed. The processes of steps S903 and S904 are again performed after the phase is shifted by one step, the processes being repeated for one period to calculate the luminance for every phase. The calculated luminance is temporarily stored in the memory. In step S906, the analog imaged signal imaged by the imaging element 101 is again retrieved with the pulse DS1 and the pulse DS2 set to the optimum values determined in advance and the ADCLK as the initial value. In step S907, the variance σ(n) within the ADCLK detection region of the retrieved analog imaged signal is calculated. n is any positive number, and represents the number of phase states that can be set within one period. That is, the variance of the signal level of each pixel within the ADCLK detection region is calculated. The process of step S907 is performed in the variance calculating unit 108. In step S908, the phase of the ADCLK is shifted one step backward with the pulse DS1 and the pulse DS2 fixed. The processes of steps S906 and S907 are again performed after the phase is shifted by one step, the processes being repeated for one period to calculate the variance for every phase. The calculated variance is temporarily stored in the memory (not shown). In this description, distribution of luminance and distribution of variance are carried out in different image retrieving processes, but may be calculated in one image retrieving process.

According to the above processes, the distributions for every phase of the luminance and the variance are stored in the memory. The optimum ADCLK is then calculated using the data stored in the memory. First, in step S909, the variance σ(1) of the first phase is set as a minimum value σ(min). In step S910, the variance of the second and subsequent phases is assumed as σ(n) and is compared with σ(min). When σ(n) is smaller, σ(n) is set as a new minimum value σ(min) in step S911. The process of step S910 is repeated until the last phase to calculate the phase at which the variance becomes minimum. In step S912, determination is made whether or not the difference between the expected value defined by the luminance at the phase at which the variance becomes the minimum value and the design specification and the minimum value is smaller than or equal to a predetermined threshold value. When the difference is within the predetermined threshold value, the phase at that point is determined as the optimum phase of the ADCLK in step S913. When the difference is greater than the predetermined threshold value, the process of step S913 is performed for the phase at which the variance becomes the next smallest after the phase at which the variance is σ(min). The processes of steps S912 and S914 are repeated until the optimum phase is determined.

According to the method described above, each phase of the pulse DS1, the pulse DS2, and the ADCLK can be automatically adjusted. Therefore, the phase of the pulse outputted from the TG 106 can be automatically adjusted when the imaging element 101 itself is replaced or when the characteristics of the imaging element are changed due to external factors (temperature, aged deterioration, etc.). Furthermore, automatic adjustment with high accuracy becomes possible since the phase of the pulse is adjusted through individual methods in view of the characteristics of each pulse.

The variance calculating unit 108, the luminance level detecting unit 109, and the timing adjusting unit 110, which are characteristic constituent elements of the present invention, may be configured by circuits as hardware or may be realized by software using a microcomputer. When the variance calculating unit 108 (variation calculating unit) and the luminance level detecting unit 109 are configured by hardware circuits, the present invention can be realized without imposing a load on a CPU.

The embodiment described above is merely an example, and it is needless to say that various modifications may be made other than the main variations to be described below.

### (First Variation)

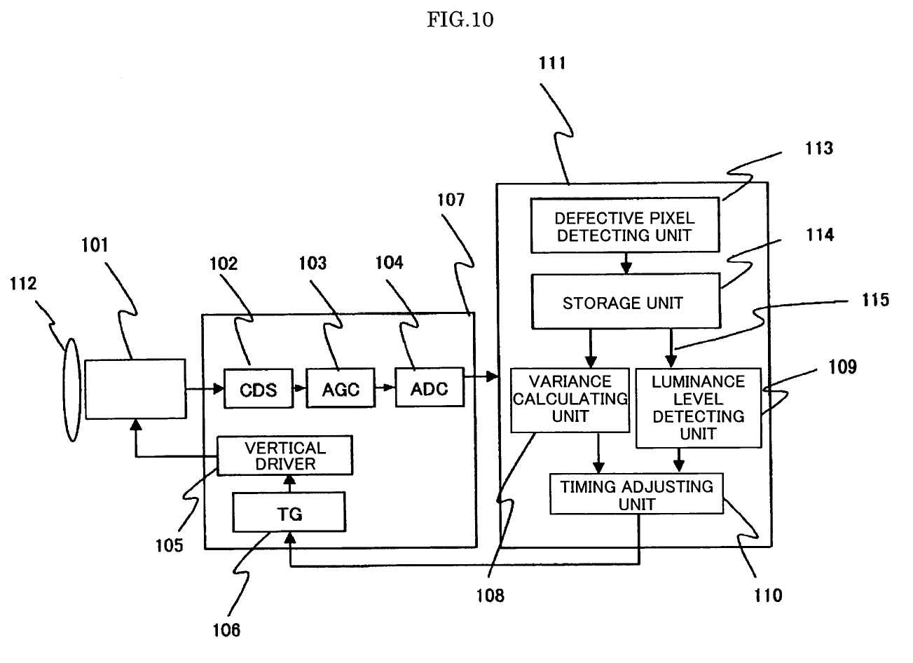

FIG. 10 shows an overall configuration of a digital camera according to a first variation in which defective pixels are not used in the automatic adjustment of the pulse. The present variation has a feature in that a defective pixel detecting unit 113 and a storage unit 114 are provided.

The imaging element 101 such as a CCD and a MOS sensor often has defective pixels resulting from manufacturing. At such defective pixels, the signal level is often fixed in the vicinity of the maximum value or the minimum value regardless of the quantity of light of the incident light. Therefore, the value of the defective pixel is desirably not used in phase adjustment even if it is within the detection region of each pulse. In the present variation, the defective pixel detecting unit 113 detects the defective pixel, and stores the address of the detected defective pixel in the storage unit 114 in advance. Accordingly, the defective pixels will not be used in the phase adjustment, and the precision of the phase adjustment can be enhanced.

The defective pixel detecting unit 113 takes various configurations, and may be a configuration in which charges for a certain time are accumulated with the mechanical shutter closed at the time of activation of the digital camera, and the pixels whose signal level is greater than or equal to a predetermined threshold value are determined as defective pixels. The storage unit 114 does not need to be configured to hold all the addresses of the defective pixels, and merely needs to store the addresses of a predetermined number of defective pixels.

### (Second Variation)

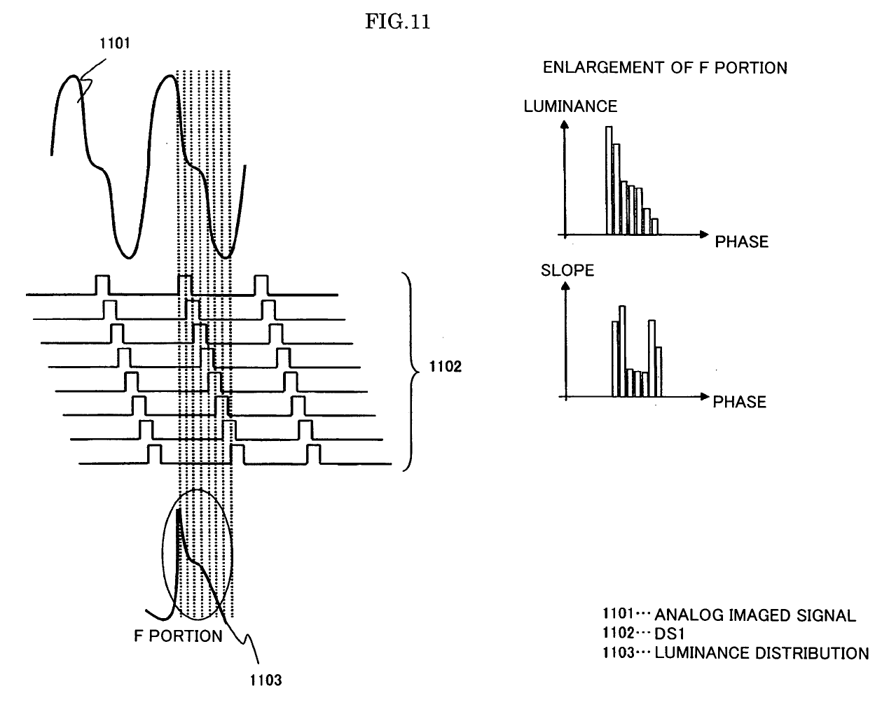

In the setting of the pulse DS1, the region in which the difference with respect to the adjacent pixel is less than or equal to the predetermined threshold value is assumed as a stable region, and pulse phase adjustment is performed so that the rising edge of the pulse DS1 comes at the center of the stable region. However, there is a possibility the phase period that becomes the stable region can not be detected when the signal quality is low, as shown in FIG. 11. Even in such a case, an area in which the slope of the signal component is relatively small can be assumed as the pseudo-stable region. To this end, in the second variation, the value of the threshold value is increased when the stable region cannot be detected, so that even the area in which the signal component has a predetermined slope is detected as the pseudo-stable region. When such a pseudo-stable region continues for a length of a certain extent, the phase adjustment of the pulse DS1 is performed so that the rising edge comes at the center thereof.

Furthermore, the method of detecting the stable region does not necessarily include only obtaining the difference with respect to the adjacent pixel as described above. Therefore, the detection of the stable region for the first time and the detection of the stable region for the second time may be different. For instance, the detection of the stable region for the first time may include calculating the difference between the average value of the luminance at three or more phases and the average value of the luminance at the current phase, and comparing the difference with the threshold value set relatively small. The detection of the stable region for the second time may include calculating the difference between two adjacent pixels and comparing the difference with a threshold value set relatively large. Therefore, the subject of the present variation is to alleviate the detecting conditions so that the stable region can be more easily detected in the detection for the second time, so that the pulse DS1 can be set even when the signal quality is low.

### (Third Variation)

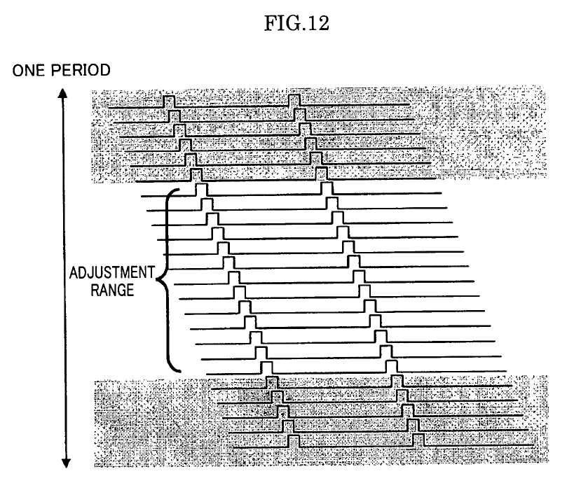

In the description of the above embodiments, the phase adjustment is performed while shifting the phase in one period to adjust the phases of the pulse DS1, the pulse DS2, and the ADCLK. However, when the design specification of the imaging element 101 is known in advance, around which phase each pulse needs to be phase-adjusted can be anticipated to a certain extent. Thus, the adjustment range may be narrower than one period as shown in FIG. 12. The time required for phase adjustment thereby is reduced.

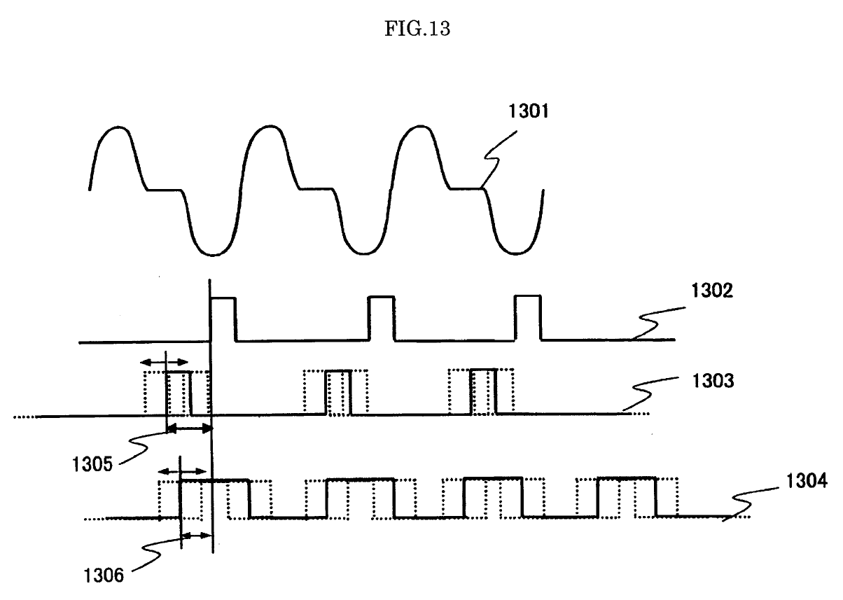

Since the pulse DS2 is adjusted first in the present variation, around which phase the pulse DS1 and the ADCLK need to be adjusted can be anticipated when the phase of the pulse DS2 is adjusted. In FIG. 13, when the phase of the pulse DS2 is determined from the analog imaged signal 1301, phase adjustment of the pulse DS1 and the ADCLK is performed only for a predetermined range before and after such a phase on the assumption that the phases of the pulse DS1 and the ADCLK should be adjusted to the vicinity of the phase of the phase difference that becomes optimum in terms of design specification. Therefore, the adjustment range can be further narrowed and the processing time required for the phase adjustment can be greatly reduced by predicting the phases of the other pulses from the phase of the pulse obtained in advance. In FIG. 13, reference numeral 1302 indicates a signal for sampling a signal output level, reference numeral 1303 indicates a signal for sampling a reference level of the signal output level, reference numeral 1304 indicates an AD clock, reference numeral 1305 indicates an optimum phase difference from the signal 1302 to the signal 1303, and 1306 indicates an optimum phase difference from the signal 1302 to the signal 1304.

Obviously, if accuracy does not need to be considered, the phases of all the pulses of the pulse DS1, the pulse DS2, and the ADCLK does not necessarily need to be adjusted, and the phases of the other pulses may be obtained with the fixed phase from the phase of the pulse that is calculated firstly, or the phase of the pulse to be obtained thirdly may be determined from the phase of the pulse obtained secondly.

The optimum phase is assumed to exist in the vicinity of the previously adjusted phase even when the phase adjustment is performed due to occurrence of phase shift by a factor such as temperature change and aged deterioration. The result of phase adjustment is stored in the memory each time, and the phase adjustment is performed with only the vicinity of the previously adjusted phase as the adjustment range when newly performing the phase adjustment.

### (Fourth Variation)

In the phase adjustment of the pulse DS1 and the pulse DS2, the phase adjustment are difficult to be performed unless the luminance is greater than or equal to a certain amount since the optimum phase is determined from the magnitude of the luminance. Since medical digital cameras etc. often have auxiliary light such as a LED, such auxiliary light may be used when the luminance at the peak was less than or equal to a predetermined value after the phase adjustment was performed once.

### (Fifth Variation)

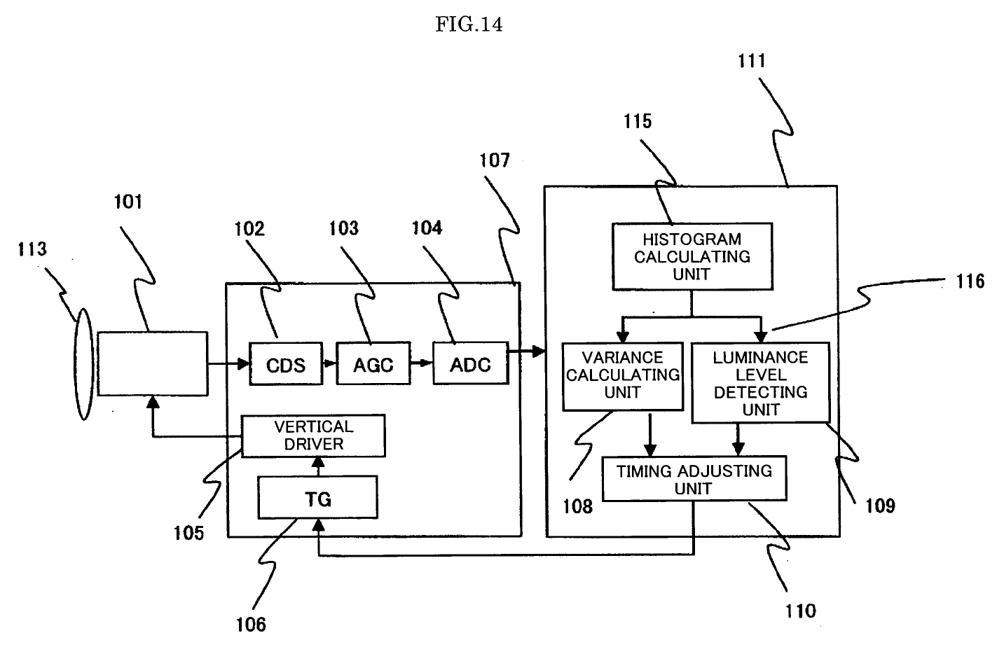

A histogram used in the present invention will now be described. FIG. 14 shows a configuration view of an automatic phase adjusting device using a histogram calculating unit. The input signal of the histogram calculating unit 115 is assumed to be signals of R pixel, Gr pixel, B pixel, and Gb pixel outputted from the imaging element 101. The histogram calculating unit 115 is adapted to specify a pixel region to be used in the calculation, a range of input signals for calculating the histogram, and a dividing number for dividing the range into sections. The histogram calculating unit 115 is further adapted to select and switch a signal serving as a target of calculating the histogram.

The histogram calculating unit 115 counts the number of appearance for every section with respect to each signal, and outputs the number of appearance for each section after the calculation of all the signals of a specified pixel region is finished. This corresponds to 116 of FIG. 14. The variance calculating unit (variation calculating unit) 108 and the luminance level detecting unit 109 both can calculate the variation value and the luminance level, respectively, from the range and the number of appearance of the signal.

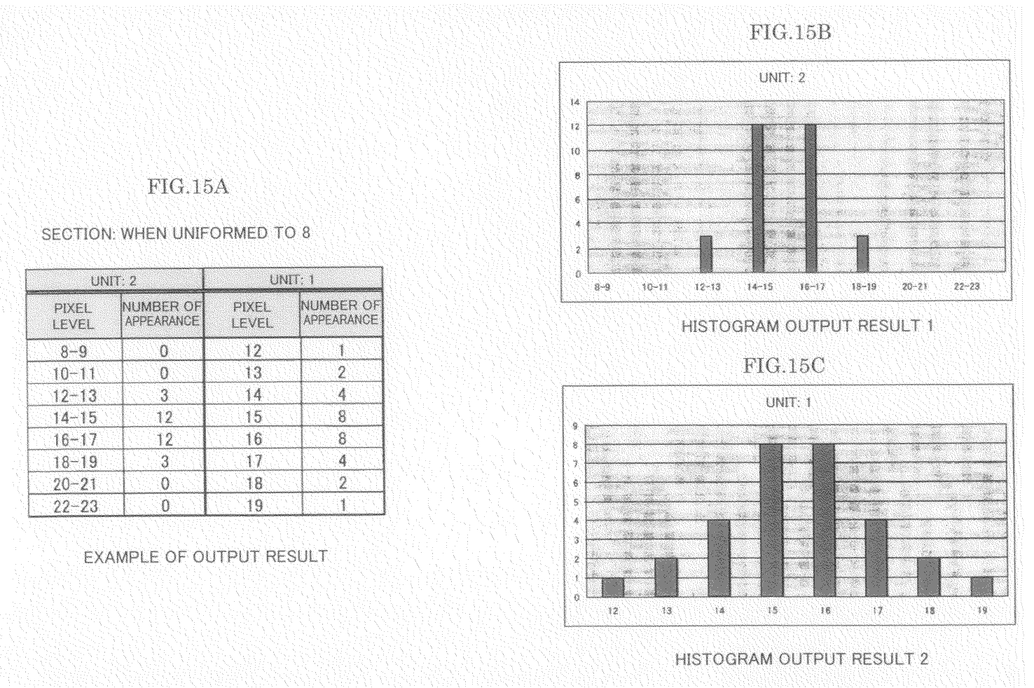

FIGS. 15A to 15C describe an application example when calculating the variation using the histogram calculating unit 115. First, as shown in FIG. 15B, a range for calculating the histogram is set large, and the range containing the input signal (analog imaged signal or digital imaged signal) is determined by referring to the histogram output result. Thereafter, as shown in FIG. 15C, the range of the input signal is changed to a value suited for automatic adjustment and the automatic adjustment may be performed. Since the precision of automatic adjustment changes depending on the combination of the signal range and the section, an appropriate value is set according to the system.

Existing digital still cameras have a function of displaying the histogram of the image after image processing, and thus the histogram calculating unit 115 can be realized by utilizing such a block without being newly arranged. The input signal when utilizing such a block is not the signal (analog imaged signal or digital imaged signal) outputted from the imaging element 101 but is the signal after image processing, and thus each parameter of image processing must be changed to a value suited for the automatic adjustment. The configuration of the histogram calculating unit 115 or the configuration using the histogram calculating unit 115 is not limited to the above. Configuration is possible without using the SDRAM by performing the automatic adjustment using the histogram calculating unit 115.

### (Sixth Variation)

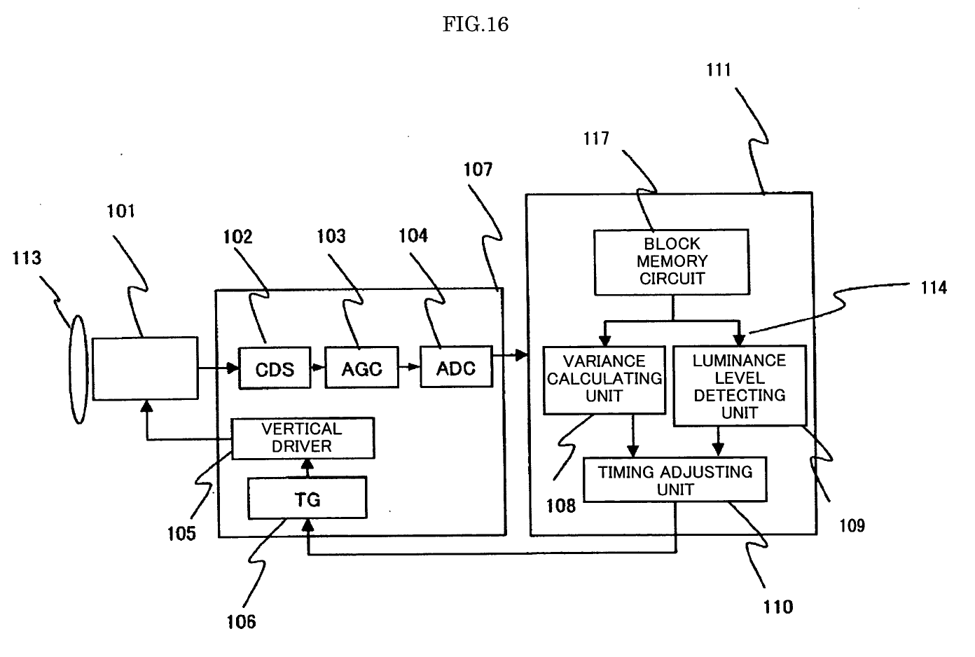

FIG. 16 shows a configuration of an automatic phase adjusting device using a block memory circuit 117. The block memory circuit 117 is arranged in the digital still camera to realize functions of exposure adjustment and automatic white balance. Signals of R pixel, Gr pixel, B pixel, and Gb pixel outputted from the imaging element 101 are inputted to the block memory circuit 117 used in the present invention as input signals. The block memory circuit 117 configures the pixel region for calculation in blocks. One block is configured by n (horizontal direction)×m (vertical direction) pixels.

The block memory circuit 117 is adapted to,

integrate data for every pixel color within one block,

output the result of integration for i (horizontal direction)×j (vertical direction) blocks while retrieving one image (while forming a frame), and

output respective integrated value of the R pixel, the Gr pixel, the B pixel, and the Gb pixel for i block(s) after integration of i block(s) is completed.

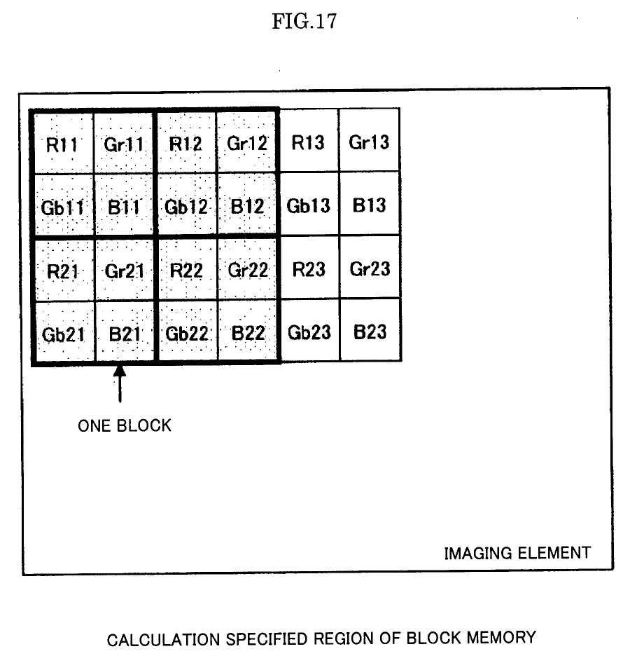

FIG. 17 shows an example of a block memory where the size of one block is 2×2, and the number of blocks is 2×2.

The size of one block and the number of blocks are preferably adjusted to appropriate values in the phase adjustment. The data with high precision can be obtained by making the size of one block small.

In the variance calculating unit 108 (variation calculating unit) and the luminance level detecting unit 109, the variation value and the luminance level can be calculated without using the SDRAM by using the output result of the block memory circuit 117 instead of acquiring the image data from the SDRAM. The pulse phase may be automatically adjusted while changing the region for calculation for every frame.

### (Seventh Variation)

A variation including a threshold value detecting unit 118 for counting the number of pixel signals satisfying the condition (threshold condition) where its signal level is

greater than or equal to a first threshold value, and

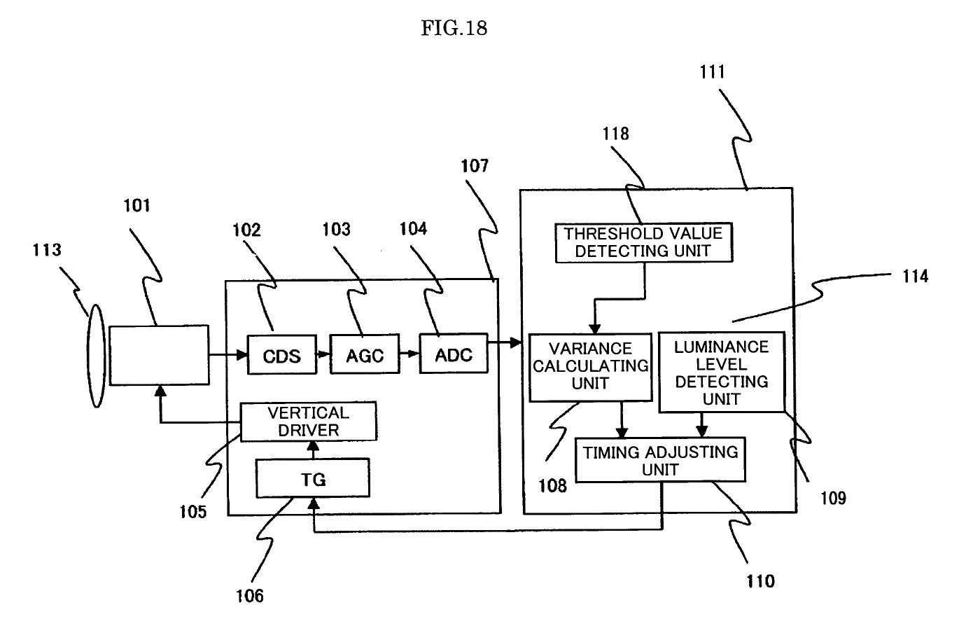

lower than or equal to a second threshold value, in the pixel signals outputted from a specified pixel region, will now be described. FIG. 18 shows a configuration view of the seventh variation.

The pixel signals of R pixel, Gr pixel, B pixel, and Gb pixel outputted from the imaging element 101 are inputted to the threshold value detecting unit 118. The threshold value detecting unit 118 counts the number of pixel signals whose signal level satisfies the above threshold condition in the pixel signal group outputted from the specified pixel region for every pixel color. The output of the threshold value detecting unit 118 can be used for the variation value by setting the first and second threshold values constituting the threshold condition to parameters suited for the automatic adjustment.

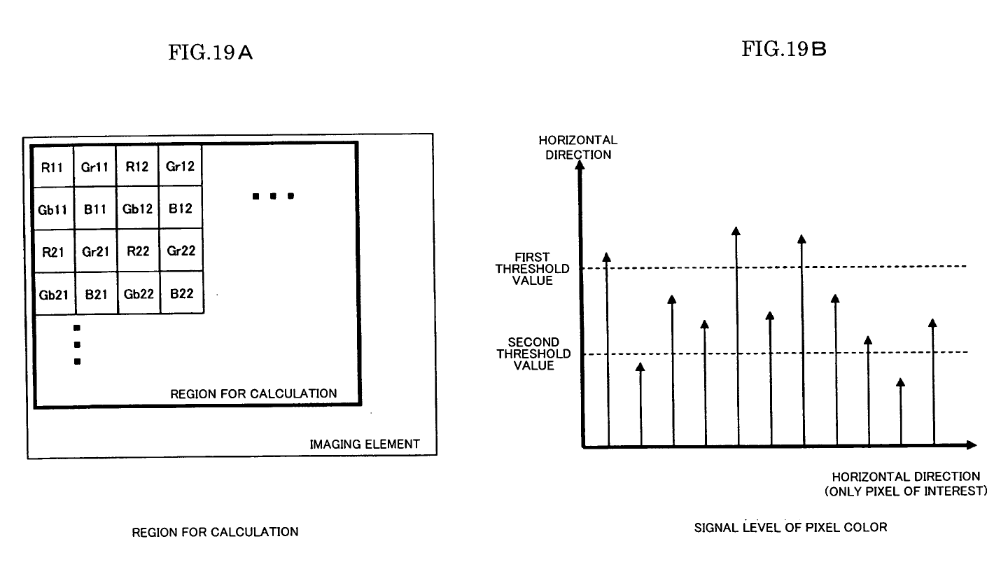

The pixel region is set as shown in FIG. 19A. Focusing on the R pixel, for example, the total number of the R pixels in the specified range can be obtained from the setting of the pixel region. As shown in FIG. 19B, the threshold value detecting unit 118 determines whether or not the signal level of each pixel signal is within the range set by the first and second threshold values, and outputs the result of the determination. The variation is determined as large when the percentage occupied by the number of pixel signals not within the range (i.e., out of the range) is large in the total number of pixel signals. According to the present variation, the phase automatic adjusting device can be configured without using the SDRAM.

### (Eighth Variation)

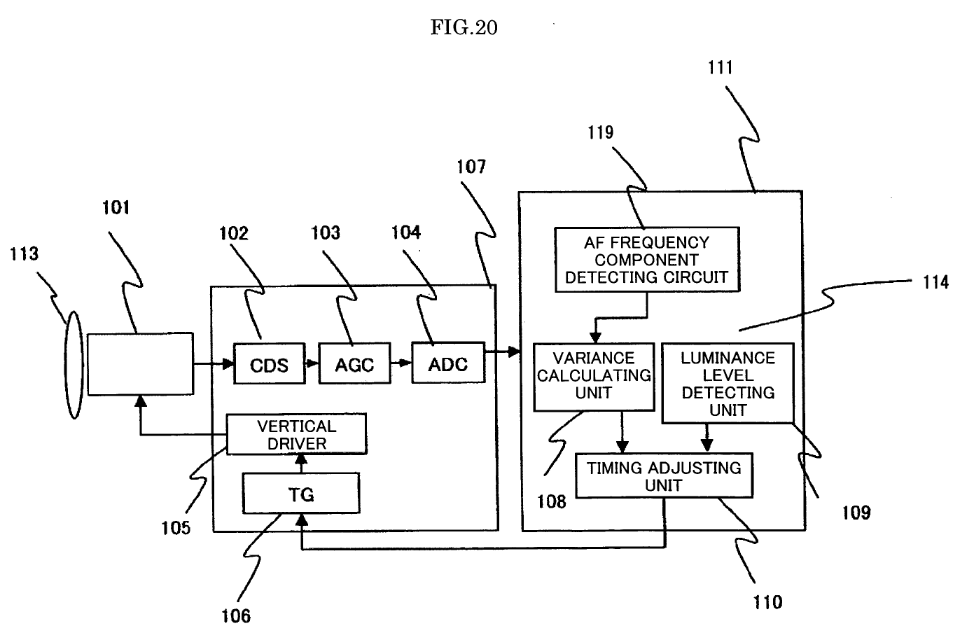

A variation in which automatic adjustment of the pulse phase is performed using a frequency component detecting circuit for automatic focus adjustment (hereinafter referred to as AF frequency component detecting circuit) 119 serving as one example of a frequency detecting block will now be described. FIG. 20 shows the configuration example. The pixel signals outputted from the R pixel, the Gr pixel, the B pixel, and the Gb pixel outputted from the imaging element 101 are inputted to the AF frequency component detecting circuit 119. The AF frequency component detecting circuit 119 can specify a plurality of pixel blocks to perform the calculation process of the signal.

The AF frequency component detecting circuit 119 includes a high pass filter (hereinafter abbreviated as HPF), where the edge information of the high frequency component of the signal can be extracted by filtering the input signal and the signals of the neighboring pixels by means of the HPF, the peak value of the edge is integrated for every pixel block based on the edge information, and the result of the integration is outputted.

In the present variation, the ADCLK is adjusted so that the variation of the phase is small when the imaging element 101 is in the light-shielded state. When the peak value of the high frequency region is large in the light-shielded state, the variation is determined as large. The present variation uses such a theory and provides the AF frequency component detecting circuit 119 to calculate the phase variation value.

In the frequency detecting block, the AF frequency component detecting circuit 119 is often mounted on the DSP 111 to realize the normal AF (AutoFocus), as described above. Thus, the present variation can be configured without newly adding a processing block by using the AF frequency component detecting circuit 119 as the frequency detecting block. In performing automatic adjustment of the pulse phase, the parameters suited not for AF but for the automatic adjustment of the pulse phase merely need to be set.

### (Ninth Variation)

A region of low frequency component may be extracted from the pixel region using the frequency detecting block (AF frequency component detecting circuit 119 etc.), and the variance and the luminance level may be calculated in the extracted low frequency component region. The low frequency component region is a region in which the noise component is few, and thus the variation value of the phase can be calculated at high precision according to the present variation.

### (Tenth Variation)

In the present variation, the supply of clock to the luminance level detecting unit 109, the variance calculating unit 108, and the timing adjusting unit 110 is stopped while the image data is retrieved. At the timing other than retrieving the image data, supply of power to the vertical driver 105 for generating the imaging element control signal is stopped.

The variations for higher speed will now be described.

### <Higher Speed by Sensor Drive: No. 1>

### (Eleventh Variation)

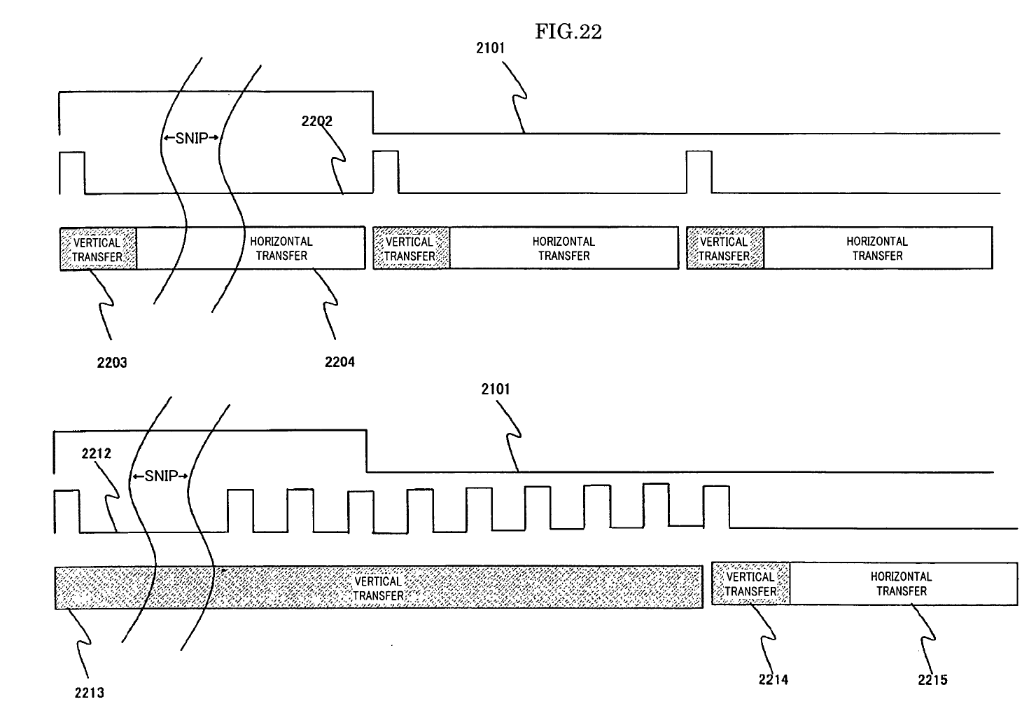

The concept of transfer of charges from the sensor will now be described with reference to FIG. 22. A vertical reference signal period 2201 (?) is a signal period that serves as a reference to configure one screen, and a horizontal reference signal period 2202 is a signal period that serves as a reference to configure one line. A vertical transfer process 2203 is a transfer process of carrying the charges read out from a photodiode configuring the imaging element (CCD) 101 to a horizontal transfer path through a vertical transfer path. A line shift is performed by the vertical transfer process 2203. A horizontal transfer process 2204 is a transfer process of transferring the charges carried to the horizontal transfer path.

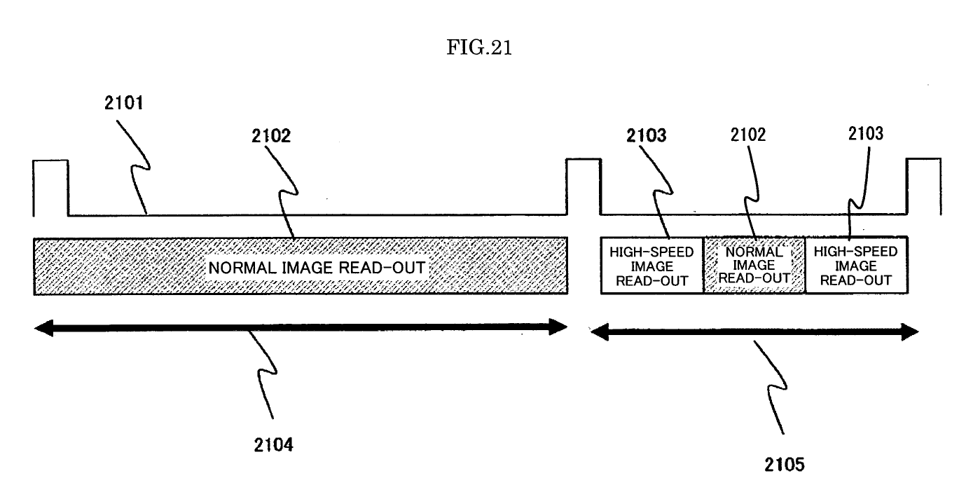

The operation of an eleventh variation will now be described. In transfer of charges, a normal image read-out process 2102 is performed during one period of the vertical reference signal 2101, as shown in FIG. 21. In the normal image read-out process 2102, after the charges worth one line are transferred to the horizontal transfer path by the vertical transfer process, the vertical transfer operation of carrying the charges of the next line to the vertical transfer path is performed. The period necessary to perform the normal image read-out process 2102 is 2104.

In the process of transferring the charges described above, the normal image read-out process 2102 is performed only on the portion to be actually detected for the automatic phase adjustment, and a high-speed image read-out process 2103 is performed on the portion that will not be used for the detection in the present variation. The image is not actually outputted during the period the high-speed image read-out process 2103 is being performed, but after rapidly reaching the line necessary for the detection by performing high-speed operation after such a period, the normal image read-out process 2102 is performed on the line necessary for the detection. Thereafter, the transfer process of the remaining lines is performed by the high-speed image read-out process 2103. According to such an operation, the period 2105 necessary for performing all the image read-out processes by using both the high speed image read-out process 2103 and the normal image read-out process 2102 is shorter than the period 2104 necessary for performing all the image read-out processes by the normal image read-out process 2102, thereby enabling the high-speed operation. The operation of the present variation will now be described in detail with reference to FIG. 22.

### <Detailed Description on Operation of Normal Drive>

The vertical reference signal period 2101 corresponds to the time length of one screen, and the pixels worth one line are outputted with the horizontal reference signal 2202 as the reference. The specific drive is as follows. That is, the charges worth one line are transferred in the vertical direction by operating the vertical transfer path by the vertical transfer process 2203. The charges worth one line are thereby transferred to the horizontal transfer path. The charges worth one line transferred to the horizontal transfer path are outputted one by one pixel at a time by operating the horizontal transfer path by the horizontal transfer process 2204. Such a horizontal transfer process 2204 is repeated for the pixels worth one line to output the data of one line. After the output of data of one line is finished, the vertical transfer process 2203 is performed to transfer the next line. The horizontal transfer process 2204 is repeated for the pixels worth one line, after the vertical transfer process 2203 is performed, to output the next line. The data worth one screen is outputted by repeating such operations.

### <Detailed Description on Operation of High-Speed Drive According to Present Variation>

The vertical reference signal period 2101 corresponds to the time length of one screen, but actually, the vertical transfer process 2213 performed from the horizontal reference transfer line to the N^{th} line is performed without waiting for the transfer of charges using the horizontal transfer path in the horizontal transfer process 2215 to be completed for the horizontal pixels. The vertical transfer process 2213 operates independently from the horizontal transfer process 2215, and actually, the vertical transfer process 2213 performs the process at high speed up to the line position necessary for the detection. The vertical transfer process 2213 can be performed before all the charges are outputted from the horizontal transfer path by independently driving the horizontal transfer process 2215 and the vertical transfer process 2213, thereby achieving higher speed of the process.

During the above operation period, the data transferred by the horizontal transfer process 2215 becomes invalid data as it is not synchronized with the vertical transfer process 2213. However, the data being invalid will not cause any problem since effective data are not necessary during this period. During the period in which the data is actually necessary, the effective data can be obtained by performing all the image read-out processes by the normal image read-out process 2102 described above. After the effective data are acquired, the high-speed drive operation of the present variation is again performed to achieve higher speed.

The process of switching between the transfer processes may be controlled by at least one of the resolution of the imaged analog imaged signal, the S/N ratio of the analog imaged signal, and the S/N ratio of the digital imaged signal. For instance, when the resolution of the analog imaged signal is sufficiently high to be used for the phase adjustment, horizontal transfer is not carried out and only vertical transfer is performed in the majority of the region, thereby achieving higher speed. When the resolution is low or when the resolution is high but the S/N ratio of the analog imaged signal itself is not satisfactory and thus the signal itself is not reliable unless a great number of lines are sampled and averaged, the percentage of performing the horizontal transfer may be increased. The reliability of the detection value can be enhanced by using only the center of the screen.

### <Higher Speed by Sensor Drive: No. 2>

A variation for achieving higher speed through a method of sampling the analog imaged signal outputted from the imaging element 101 will now be described.

### (Twelfth Variation)

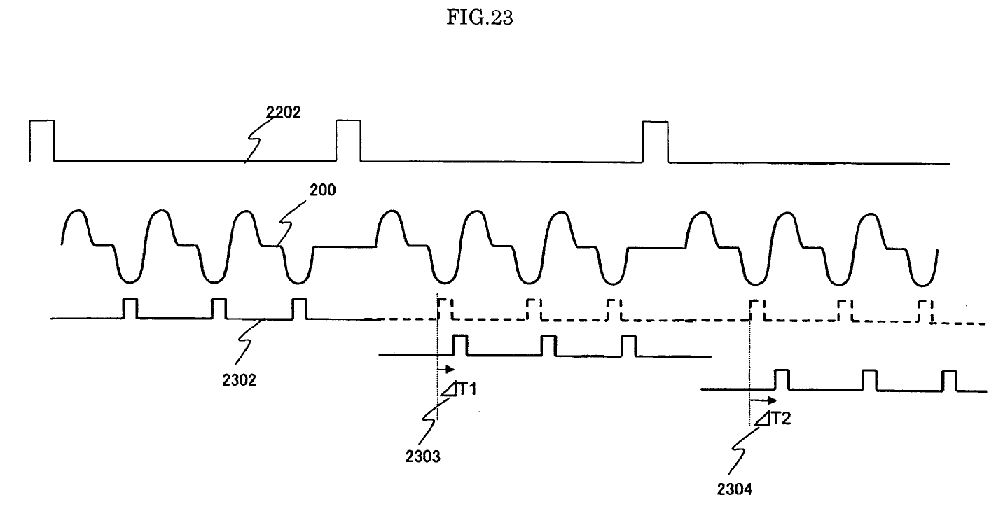

The method of sampling the analog imaged signal will now be described with reference to FIG. 23. In determining the output level of the signal, the CCD output 200 is outputted for the horizontal pixels, and the signals are sampled in synchronization with the pulse DS2 (indicated by reference numeral 2302 in FIG. 23) to determine the output level of the signal in the horizontal reference signal period 2202. That is, the output timing of the pulse DS2 (2302) is determined in the timing adjusting unit 110, and the signal level is determined.

In the present variation, the output timing of the pulse DS2 (2302) is operated with independently different parameters for every horizontal reference signal period 2202 to check the luminance level corresponding to a plurality of phases in one screen. Specifically, in the next horizontal reference signal period 2202, the pulse DS2 (2302) is outputted at a timing shifted by ΔT1 (2303) with respect to the first horizontal reference signal period 2202. In the further next horizontal reference signal period 2202, the pulse DS2 (2302) is outputted at a timing shifted by ΔT2 (2304) with respect to the first horizontal reference signal period 2202.

The phase of the data can be microscopically moved at high precision in one data retrieval by performing the output adjustment of the pulse DS2 (process of shifting the output timing of the pulse DS2 (2302) respectively to Δl−Δ(N−1) for the imaging element 101 in which one screen is configured by N lines).

Further increase in processing speed can be achieved by setting the phase independent for every line and detecting a plurality of sampling patterns in one screen. Such a configuration allows the present invention to be applied even to the field of in-vehicle device etc. in which real-time property of the process is extremely important.

The unit of change in phase is desirably changed based on at least one of the resolution of the analog imaged signal, the S/N ratio of the analog imaged signal, and the S/N ratio of the digital imaged signal. For instance, when the resolutions of the analog imaged signal and the digital imaged signal are sufficiently high as pixels to be used in the phase adjustment, the phase may be changed for every large number of lines. When the resolution is high but the S/N ratio of the signal itself is not satisfactory and thus the signal itself is not reliable unless a great number of lines are sampled and averaged, the phase must be changed for every large number of lines larger than that for the above-mentioned phase adjustment. When the resolution of the analog imaged signal is low but the S/N ratio of the analog imaged signal and the digital imaged signal is satisfactory and thus the process of averaging and processing the large number of lines is not required, the phase may be changed for every small number of lines.

### <Higher Speed by Memory Control>

### (Thirteenth Variation)

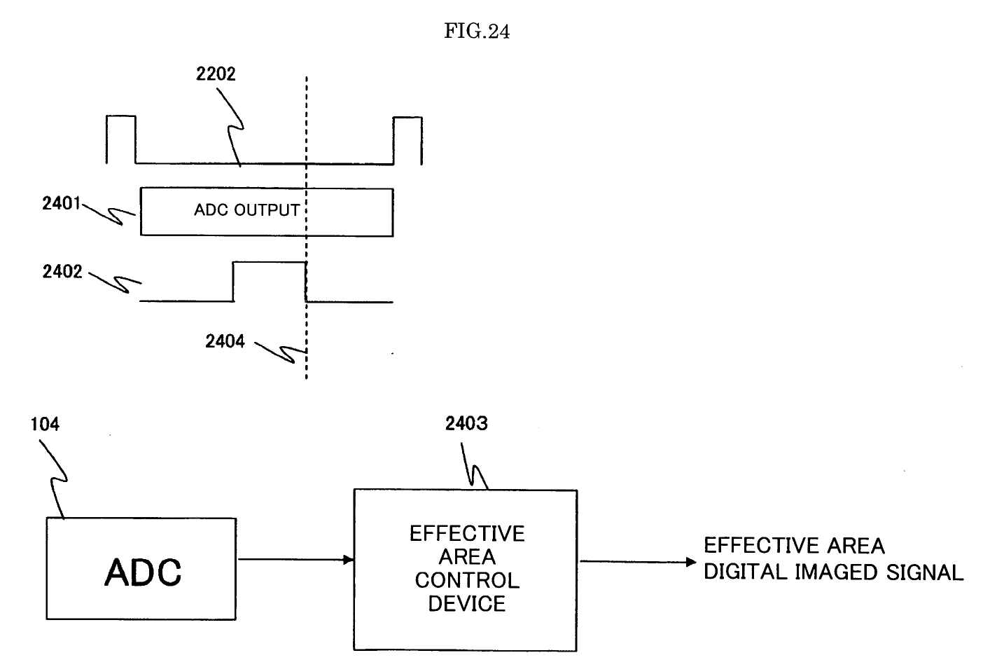

A thirteenth variation in which the method of storing in the memory and various processes are improved for the digital imaged signal digital converted by the ADC 104 after performing the correlated double sampling of the signal by the CDS 102 will now be described with reference to FIG. 24.

A effective area control device 2403 is further provided in the present variation. The effective area control device 2403 selectively retrieves only the data of the effective area (hereinafter referred to as digital image output of the effective area) that is necessary in unit data area of the digital image signal digital converted in the ADC 104 after performing the correlated double sampling by the CDS 102, and stores the data in the memory. Specifically, the effective area 2402 is set in the ADC output 2401 during the horizontal reference signal 2202 period, and the effective area control device 2403 retrieves the ADC output 2502 and proceeds to the next operation at the timing 2404 when the effective area 2402 is finished. The effective area control device 2403 stops the clock to be provided to the horizontal and vertical transfer units during the period other than the effective area 2402.

Through such processes, the processes can be performed with the minimum memory size necessary for the automatic adjustment. The process can be started at the point where the necessary data are ready, thereby further realizing higher speed. In other words, when the image has sufficiently high resolution assuming the application is for the automatic adjustment, the data area to be stored may be reduced (specifically, reduce the period length of the effective area 2402) to realize higher speed. When the resolution is low, or when the resolution is high but the S/N ratio of the signal itself is not satisfactory and thus the signal itself is not reliable unless a plurality of lines is sampled and averaged, the data area to be stored may be enlarged (specifically, increase the period length of the effective area 2402) to enhance the reliability.

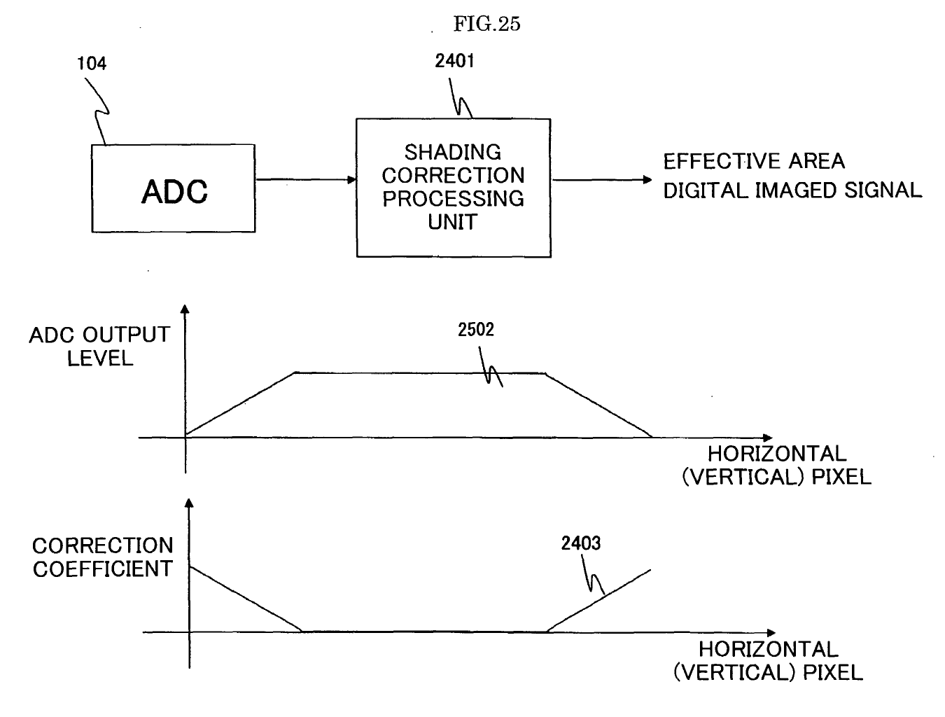

Moreover, the reliability of the detection value can be enhanced by setting the effective area 2402 only at the center of the screen. As shown in FIG. 25, in the ADC output level 2502 of the retrieved data, both ends of the screen have a lower level vertically and horizontally compared to the central part of the screen. This is based on the shading of the lens. Due to such a feature, only the data at the central part of the screen is desirably sampled. Alternatively, as shown in FIG. 25, a shading correction processing unit 2401 may be arranged, and a correction coefficient 2403 for correcting the reduction in the quantity of light of the surrounding that occurs by the lens shading is set in the shading correcting unit 2401. The reliability of the signal thus can be enhanced by multiplying the ADC output level 2502 by the correction coefficient 2403 by the shading correcting unit 2401.

The higher speed control by the sensor drive described in the eleventh and twelfth variations is performed by the effective area control device 2403 in FIG. 24, and the like.

Although the present invention has been described in its preferred form with a certain degree of particularity, it should be understood that the combination and arrangement of the parts may be modified in various ways without departing from the spirit and the scope of the invention as hereinafter claimed.

What is claimed is:

1. An automatic phase adjusting device for adjusting a phase of a pulse used in an imaging process based on a digital imaged signal obtained by converting an analog imaged signal generated in the imaging process by an imaging element to a digital value for each pixel; the automatic phase adjusting device comprising:
a luminance level detecting unit for calculating a luminance of the digital imaged signal in a plurality of pixels within a first pixel region in the imaging element;
a variation calculating unit for calculating a variation value indicating signal variation of the digital imaged signal in a plurality of pixels within a second pixel region in the imaging element; and
a timing adjusting unit for adjusting the phase of the pulse based on the result of calculation of the luminance level detecting unit and the result of calculation of the variation calculating unit.

2. The phase adjusting device according to claim 1, further comprising an effective area control device for setting an effective area used in a luminance calculating process by the luminance level detecting unit and a variation value calculating process by the variation calculating unit in a unit data area constituting the digital imaged signal, wherein
the variation calculating unit and the timing adjusting unit perform respective process using data of the effective area set by the effective area control device.

3. The phase adjusting device according to claim 2, wherein the effective area control device adjusts a size of the effective area based on at least one of resolution, S/N ratio of the analog imaged signal, and S/N ratio of the digital imaged signal.

4. The phase adjusting device according to claim 2, wherein the effective area control device sets a transfer processing speed of a pixel transfer pulse in a period of outputting data area of the digital imaged signal other than the effective area as a speed different from a transfer processing speed of a pixel transfer pulse generated by the timing adjusting unit in a period of outputting the effective area.

5. The phase adjusting device according to claim 4, wherein the effective area control device sets the transfer processing speed of the pixel transfer pulse in the period of outputting the data area of the digital imaged signal other than the effective area faster than the transfer processing speed of the pixel transfer pulse generated by the timing adjusting unit in the period of outputting the effective area.

6. The phase adjusting device according to claim 4, wherein the effective area control device adjusts a period length of the effective area based on at least one of resolution, S/N ratio of the analog imaged signal, and S/N ratio of the digital imaged signal.

7. The phase adjusting device according to claim 1, wherein the timing adjusting unit controls the phase of the pulse independently for each line.

8. The phase adjusting device according to claim 7, wherein the timing adjusting unit controls a first pulse used in detecting a signal level of the analog imaged signal, a second pulse for detecting a signal level that acts as a reference in a correlated double sampling process performed in generating the digital imaged signal, and a pulse of an AD clock signal used in generating the digital imaged signal independently for each line.

9. The phase adjusting device according to claim 7, wherein the timing adjusting unit controls the phase of the pulse independently for each line based on at least one of resolution, S/N ratio of the analog imaged signal, and S/N ratio of the digital imaged signal.

10. The phase adjusting device according to claim 2, wherein the effective area control device is adapted to perform control such that a digital image signal of the effective area is outputted after being subject to a storage process, and to selectively output a clock used in the storage process only during the storage process of the effective area.

11. The phase adjusting device according to claim 2, wherein the effective area control device arranges the effective area in a unit data area such that the effective area is arranged at a center of a screen formed based on the digital imaged signal.

12. The phase adjusting device according to claim 1, further comprising a shading correction processing unit for performing shading correction on the digital imaged signal, wherein the luminance level detecting unit and the variance calculating unit perform respective processes based on the digital imaged signal subject to the shading correction by the shading correction processing unit.

13. A phase adjusting method of adjusting a phase of at least one of a first pulse used in detecting a level of an analog imaged signal outputted from an imaging element, a second pulse for detecting a signal level that acts as a reference in a correlated double sampling process performed when converting the analog imaged signal to a digital value for each pixel, and an AD clock signal used in converting the analog imaged signal to the digital value for each pixel, the method comprising the steps of:
detecting a first phase at which a luminance of the analog imaged signal becomes maximum with the second pulse and the AD clock signal fixed at respective initial values and the phase of the first pulse changed; and
setting the detected first phase as the phase of the first pulse.
